(19) United States
(12) Patent Application Publication
(10) Pub. No.: US 2017/0263135 A1
(43) Pub. Date: Sep. 14, 2017

(54) Analyzer systematic and reducing human faults system in aircraft flight

(71) Applicant: Ehsan Rezaei Gerovi, Mashhad (IR)

(72) Inventor: Ehsan Rezaei Gerovi, Mashhad (IR)

(21) Appl. No.: 15/068,651

(22) Filed: Mar. 14, 2016

(51) Int. Cl. G08G 5/00

(52) U.S. Cl. CPC G08G 5/0047

(57) ABSTRACT

A new analyzer system with reduced human error in aircraft flights; performing the duties such as translation and interpretation of reports, coding of navigation, speech to text conversion, auto representing of the proposed answers to the pilot, exploitation of information from frequency ATIS, schematic representing from flight in online form and prediction the next movement and tracking it (aircraft) and also displaying flight calculations.

### TECHNICAL FIELD OF THE INVENTION

The current invention shows an applicatory system, useful in navigation industry for civil, cargo, training, and general aviation aircrafts, and it's duty is to analyze and to reduce human faults before, during and after flight.

### BACKGROUND OF THE INVENTION

Navigation reports such as METAR: normal weather report issued at hourly intervals, which is used for airline and aviation industry: this report is represented in code. SPECI: special weather report from the station or the station located in the airport issued at two-hours intervals. TREND: weather report of the station located in the airport with prediction of the climate changes in the next hours, which is represented in code. TAF: the report of prediction of climate changes for the airport that is represented in code. NOTAM: the necessary information of the road or the airport with risks and limitations applied before and during the flight that is represented in code.

All of the mentioned reports are the necessary information that every pilot requires before and during flights and especially at approach and landing in the airport. The method and manner of conveying this information has been coded since 1996 to prevent loss of time and to make transfer of information fast enough. Furthermore it is the responsibility of the pilot or the flight crew (in other words the human factor) to decode and translate the information since then.

The Method of voice recognition and conversion of voice to text and back is well known in the art.

There are systems named as Flight Data Recorder (FDR) and Cockpit Voice Recorder (CVR) in the aircrafts. FDR is for recording all aircraft movements in a yellow or an orange box which is known as Black Box by the public. This recording of information (FDR) is useful in the cases of any kind of air crash, when the expert teem gain the information from inside in their special laboratories to discover the reason of the accident. CVR is made up of numerous microphones inserted in the Cockpit to record all the conversation made between the flight crew. Like the FDR, it is used to check the accident by the expert teems.

Undoubtedly you are familiar with systems such as Radar and GPS, and the basis of their operation. These tools show the relative location of the aircraft in the air on their monitors by using radio and satellites waves, which absolutely have a series of faults such as: atmosphere faults (involving atmosphere delay and troposphere features), satellite faults (involving circuit fault and satellite time fault), receiver faults (involving multi routes fault, noise and fault of receiver time). Cycle slip fault, fault of antenna replacement and also intentional receive of the SA fault waves. These waves are sent by Defense Ministry of USA along with other waves from GPS satellites toward nonmilitary receivers in order to cause a 3-5 m fault in concentration, or blind spots located on the earth intentionally or unintentionally. GPS have three codes that most of people use the C/A code, which has middle exactness. Code P and Y have high exactness and are used by American and NATO militaries.

European commission has started especial programs for studying in the field of air traffic management, administrative address navigation, technical and practical concepts for transportations, navigation and air traffic safety through Satellite SES (Single European Sky). in this project there is a GPS in any passenger bus. This module processes the results using a satellite and a Trace. The outcome is shown on the monitor in the office so the route and the location of the bus will be presented. It is done by determining the location of the bus at any moment by sending signals from the GPS to the satellite and from the satellite to the office on the map.

Aeronautical Information Publication (AIP) involves all the navigation information of a country containing general and special rules, Air corridor, En-route, airports and exact facilities and approach charts and also standard instrument departure (SID) and standard arrival route (STAR).

Pilot operating handbook (POH) is a handbook containing all the necessary operational information about aircraft. This information include aircraft features, its operations and their necessary weight and balance its efficiency in the various conditions, and the most important part is that in the emergency situation he must refer to it and do exactly what it says.

### SUMMARY OF THE INVENTION

The system mentioned as analyzer system and reducer of human faults in flight of trade aircrafts, includes a unique method which minimizes the percentage of faults made by the pilot and the flight crew, and increases the accuracy and exactness significantly, this system involves six main sections including: (FIG. 11).

The Section called Translate Code getting benefit from artificial intelligent translates the codes relating to the navigation reports and represents it to the pilot or flight crew in human language. (FIG. 1)

Section Convert, with using the technology of auto identification of talking and development converts the conversations to the text simultaneously. Then by using the Neural Network and artificial intelligent processes the represented text, and displays the expected reaction of the pilot on the monitor. Since the span of navigation conversations is limited they can be predicted. (FIG. 3).

Part ATIS is the abbreviation of Aerodrome Traffic Information service, this part gets the information from ATIS frequency and after process converts them to the text and represents on the monitor. The ATIS is a frequency that the control unit of flight of any airport records vital information and distributes it by the above frequency every 30 minutes (every hour or every 45 minutes, 15 minutes, 10 minutes, 5 minutes, or any setting that the pilot chooses). So that any person requiring them has access to it and there is no need to call the control unit. In other hand when a pilot decides to enter to the approach, there will be increases in his work load and at the same time it is necessary to listen to this frequency and note the required information (FIG. 5).

Flight analysis can position through using the radar and GPS satellites and then it processes the position and represents the online movements of the airplane on the monitor, so it compares the flight root with the predetermined maps of navigation to the pilot.

In section Kneeboard the system can after setting the departure and destination manually by the pilot and flight crew, display the information as well as frequencies of flight control unit, navigation frequencies, required heights, compulsory report, alternate route, alternate aerodrome, all of the current information in AIP, access to POH text, ability of sounding of Emergency section in this section show just with a key.

Scanner section is input section of the system, and the entries of scanner and USB are controllable from this section.

### BRIEF DESCRIPTION OF DRAWINGS

FIG. 1: is a view of a window known as Translate Code Page.

FIG. 2: the front flow chart shows the method of operation of Translate Code Page.

FIG. 3: is a view of a window named Convert page.

FIG. 4: the front flow chart shows the method of operation of Convert page.

FIG. 5: is a view of window named ATIS Page.

FIG. 6: the front flow chart shows the method of operation of ATIS page.

FIG. 7: is a view of window named Flight Analysis Page.

FIG. 8: is a view of window named Knee Board Page.

FIG. 9: is continuing of a view of window named Knee Board Page.

FIG. 10: displays continuing of a view of window named Knee Board Page.

FIG. 11: displays view of the main window.

### DETAILED DESCRIPTION

Every day in the world, hundreds or thousands of aircrafts flight in atmosphere from a point to another, and transforms a lot of people and goods. However, this method of transformation usually faced potential risks and problems. A large part of these risks and events are made due to human factors which are called as (flight crew). The analyzer system is used with the aim of reducing human faults in trade aircraft flights; this is done by analyzing issues that result in most events, and by pointing the faults of the pilot before the event, in order to prevent these problems. The above system starts its work before flight and it continues until the end of flight in order to increase the flight quality.

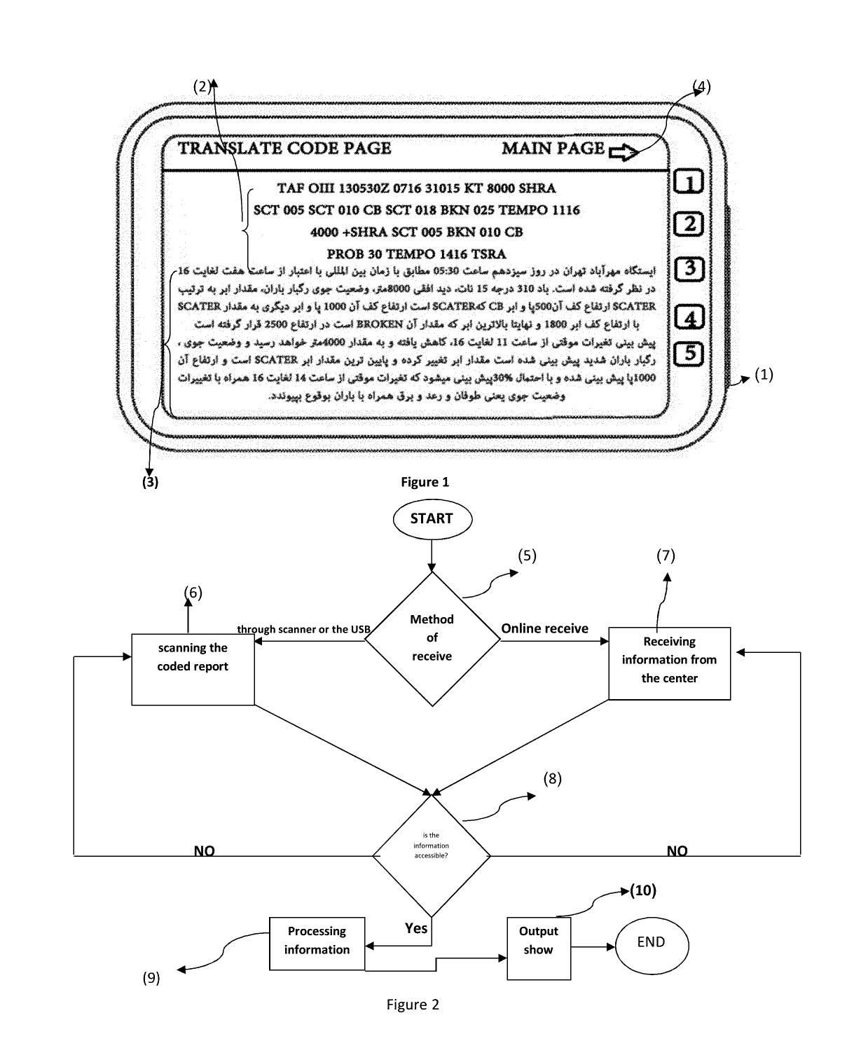

Then, we want to study the need for describing the function of this system in the flight. So at first we need to get information about the climate where we are going to fly, then we should analyses them in order to prevent its risks. This information is accessible in the form of Aviation encrypted codes such as (METAR: normal weather report issued at hourly intervals, that is used for airline and aviation industry), (SPECI: special weather report from the station or the station located in the airport issued at two-hours intervals.), (TREND: weather report of the station located in the airport with prediction of the climate changes in the next hours, that is represented in code) which are made and published by the MET Briefing Office, and the duty of translation and analyze is on the pilot. There is a sample of encrypted report is represented below: (FIG. 1; Part 2),

$$\{ \begin{matrix}TAF OIII 130530 Z 0716 \; 31015 KT 8000 SHRA \\ SCT 005 SCT 010 CB SCT 018 BKN 025 TEMPO 1116 \\ 4000 + SHRA SCT 005 BKN 010 CB \\ PROB 30 TEMPO 1416 TSRA \end{matrix}$$

This report is interpreted as follows: (Figure: Part 3). The Prediction of the climatic conditions of Tehran station (OIII) in day 13 at 05:30 is reported in accordance with the determined international time, and its validity time is considered from 7 to 16. the wind is 310 degree, 15 knot, horizontal view 8000 m, raining condition, amount of cloud according to Scatter, cloud base height relative to the ground is 500 foot and cumulonimbus cloud that is scatter, the base height is 1000 foot and other cloud in scatter amount with the base height of 1800 and finally highest cloud that its amount is Broken and its height is 2500 foot.

Predictions of temporary changes from 11 to 16, the view will be reduced to about 4000 m, and for climatic condition, storm and sever raining is predicted. The Amount of clouds will change and the amount of the lowest scatter cloud with the height of 1000 foot is predicted 30%. the temporary changes from 14 to 16 is predicted to be along with the climatic changes, that is storm and thunder with raining.

In trade aircraft flights the Analyzer and reducer of human faults system at first gets the coded information in two ways: 1—leaf scan (FIG. 11; Part 62) 2—receiving through internet channel (FIG. 11; Part 60), then exchanges this information for text and transmits it to the Translate code page (FIG. 1). In this page the information is processed and decoded (FIG. 2), and represented on the monitor for the pilot (FIG. 1; Part 2 & Part 3).

Before starting any aircraft the pilot is required to ask for the starting permission from the Watchtower, after that he should check any action such as route clearing, taxing, taking off, holding, approach and . . . with the control unit in navigation formal language and adopted with annexes of global navigation organization ICAO (Document 9432 Manual Radio Telephony), and achieve the required licenses, and announce them as it is provided in detail in annexes. Since the formal language of navigation is English.

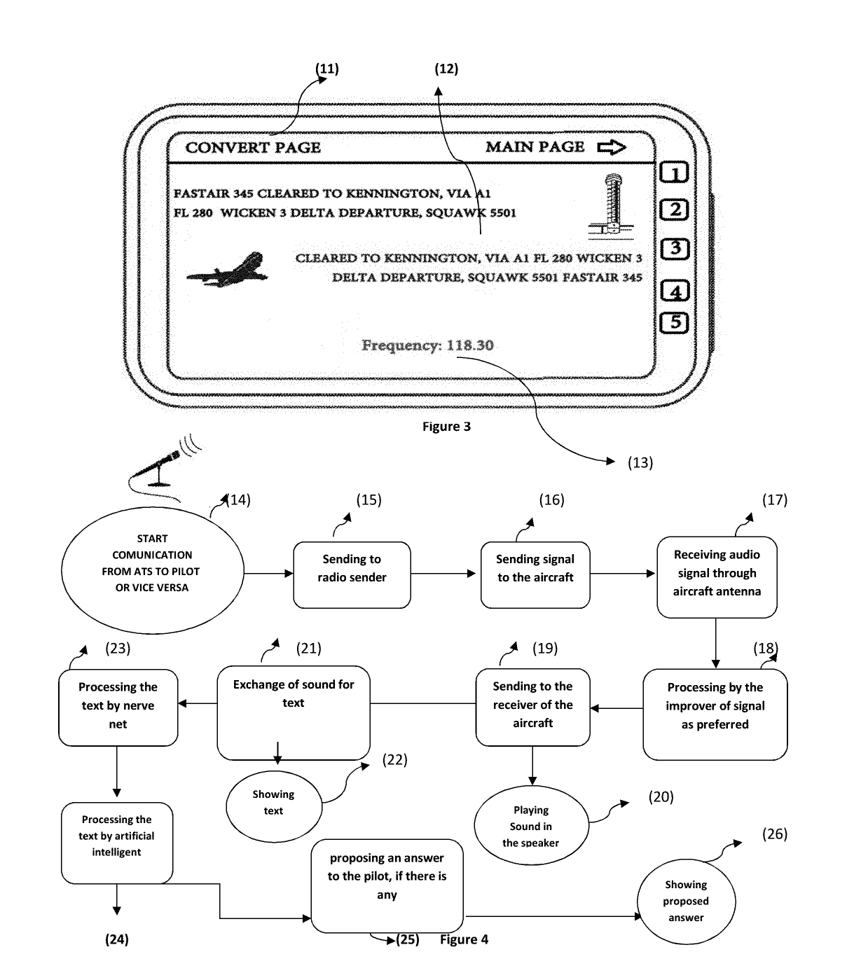

In many cases, even when the tower or flight crew is native English, there are misunderstandings and even not comprehending the exact means of the other party and so they act in a way those results in disaster. Therefore the analyzer and reducer of human faults system in trade aircrafts flights receive the radio signals through radio antenna of the aircraft (FIG. 4; Part 14, Part 15, Part 16, Part 1) and improve them with the improvers that where considered for the job (FIG. 4; Part 18) and send them to the analyzer system (FIG. 4; Part 19). The system represents them simultaneously in two forms of microphone and audio (FIG. 4; Part 20), and also by using the technology of identification of talking in text form (FIG. 4; Part 21) for the pilot (FIG. 3; Part 11, Part 12). In the following we explain the basics of changing radio talking to text for more comprehension.

The aim of diagnosis of talks known as Speech Recognition in science, is to design and perform a system that receive talking (vocal) information and extract the text and the order of speaker (FIG. 3; Part 11, Part 12). The technology of speech recognition enables a system that receives the sound (for example Radio, and audio Medias inside the airports) recognize the user speech. This technology is used in exchanging conversation for text (FIG. 3; Part 11, Part 12).

There are different types of speech Recognition systems, some can recognize continuous speech, but some others can only recognize discrete speech (where there is silence between words), but the analyzer and reducing human faults system in the trade aircraft flights are able to recognize the words pronounced by various people, or only one person depending on the settings. In any way the ideal analyzer and reducer of human fault system used in the trade aircrafts is the one that can recognize the non-dependent continued speech to the speaker in the noisy environment.

These systems can recognize words through using various methods of classification and recognition of the samples. Of course in order to increase accuracy in recognition navigation and general dictionary is used at the end of system. Methods like Hidden Markov Model or Neural Network are used in many speech recognition systems, and in the final part of the system the artificial intelligent is used, like what we have done (FIG. 4; Part 23, Part 24).

In addition to the fields of signal processes especially audio signals and automatic speech recognition, we can study other fields such as increasing speech quality, converting speech to text, processing natural languages as well as statistical, grammar and language methods. Also these products may be developed to other languages depending on orders. The used reinforcement methods are as the following:
methods rely on feature including: liftering, RCC, RASTA-PLP, PCA, CMS
methods of improving during speech: spectrum reduction, microphone Array, and beam-forming
methods relying on adoption: MLLR, MAP
methods relying on prediction: PMC
methods relying on normalization of the speaker: VTLN
possible model of the single, couple, tripled and four words for Persian and English languages
GPSP grammar rules for Persian language
probable language grammar
suitable parsers of model language
methods of word clustering

One of the speech recognition applications is its use in radio Telephone systems in which the user could watch the transmitted text just as expressing the desired title. (FIG. 3; Part 11, Part 12). Recognition of radio speech has especial complexities due to the especial conditions of Radio like channel noises, band width limitations, variety kinds of phones, changes of sound severity, variety of speakers and variety of accents.

The Analyzer and reducer of human faults system in trade aircraft flight is equipped with various methods of reinforcement so that they can be applied in the real applications. The Speech recognition engine for these processors is such that they do the recognition in a speedy and accurate form. The audio translation software and performing audio programs are two samples of this innovation.

Recognition of the key words of speech means finding an especial word or sentence in speech that is used for prediction of pilot's answer in this system. Such that after changing speech to text with extraction of key words, the answer is presented under the converted text using the nerve channel and artificial intelligence. (FIG. 4; Part 23, Part 24).

This part of the system in addition to converting radio speech to the text and representing proposed answers to the pilot (FIG. 3; Part 11, Part 12), leads to prevent forgetting a note from conversation, because of workloads on flight crew during flight. and on the base of the issue that there are many problems during flight for flight crew, maybe that note lead to huge danger, so it is one of the advantages of the cited system. (FIG. 3; Part 11, Part 12)

Information of the airport such as active runway, figure of airport pressure system the, active ILS, temperature, wind, moisture and . . . , are information that are recorded automatically previously through specialized frequency in nay airport that is called aerodrome traffic information, is read for the pilot.

This information involve important issues, and because of its importance, the pilot has to spend much time for listening to it and maybe make notes and practically amuse her mind for listening to them over and over.

The Analyzer system is able to receive all the audio information while entering to ATIS PAGE (Figures; Part 27, Part 28, Part 29) by setting the frequency and to represent it to the pilot (FIG. 6; Part 34) with two fast processes (FIG. 6; Part 30, Part 31, Part 32, Part 33) of the text due to the importance of information. This issue increases the safety and reduces the workload of the pilot.

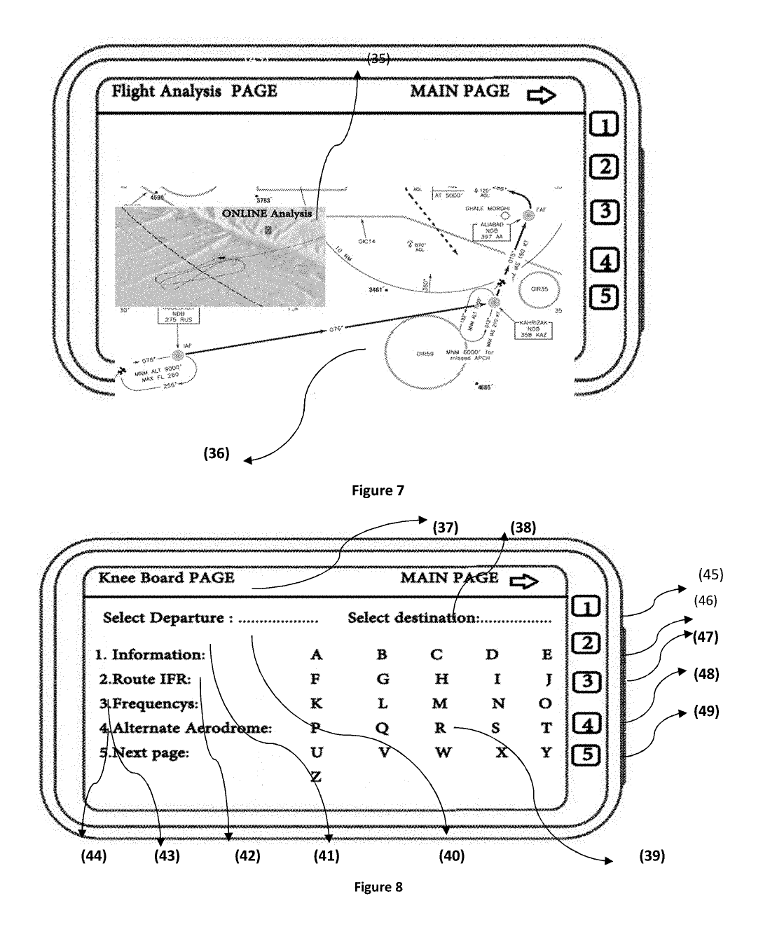

Schematic representation of the ongoing flight and prediction of the next movement without using satellite (FIG. 7; Part 35, Part 36) and also representing flight calculations for the way of departure (SID=Standard Instrument Departure), arrive (STAR=Standard Arrival Route), approach, and cruise flight and adoption of aircraft movement form the beginning until the end with navigation charts are some of the services that are represented in the section of flight analysis page ((FIG. 7; Part 35, Part 36).

In this section the pilot is able to observe his flight in Linear schematic form, and also observe adoption and non-adoption with designs and charts simultaneously, also figuring out the possible mistakes in the next step using this Page, also it can help the pilot finding the accurate directions. (FIG. 7; Part 35, Part 36)

For better understanding of the process of this system, we will point to an important part of the flight where this unique systems has come to help and has assisted the pilot significantly. Of course, it is important to note that the above information is by of the satellite.

Approach plane is so important and the pilot should focus to it so much, since the first fault surely will have many issues and problems. One part of the approach plane is the Holding, the entrance, the form and the aspects of which are so important. The pilot should from the beginning bear the calculations in his mind make it on mental basis. Since the pilot may not watch the linear schematic of the holding he made in the mind, the probability of mistakes is very high, and even in many cases lead to unintentional accidents.

ARC also is so important in approach plane. to be toward left or right of the route ARC is so important and vital. However, unfortunately the pilot should perform this maneuver in his mind, and the linear schematic of the aircraft in the flight like the quality of flight, is not presented by any of the Navigation aid equipment. Information in the approach plane such as width and length of runway, DA/H, MAD/H, active and alternative communication frequencies, navigational aid frequencies, airport height above mean sea level and continuously investigation of the height during approaching and arriving to the runway for landing and should be clearly observable for the pilot, so that he can observe it at any moment, these problems are solved by analyzer and reducer faults system.

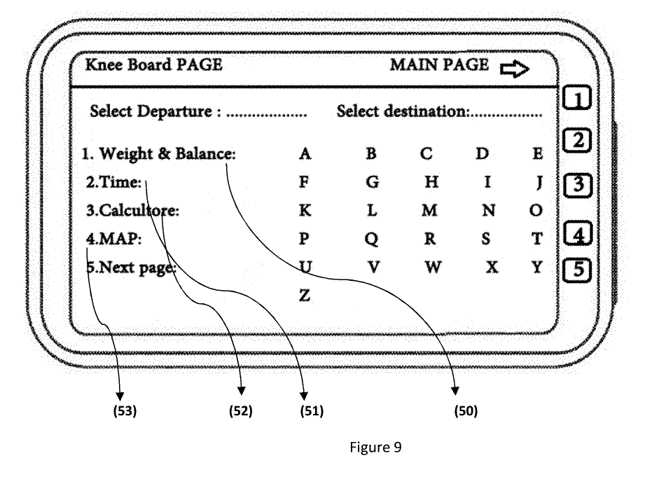

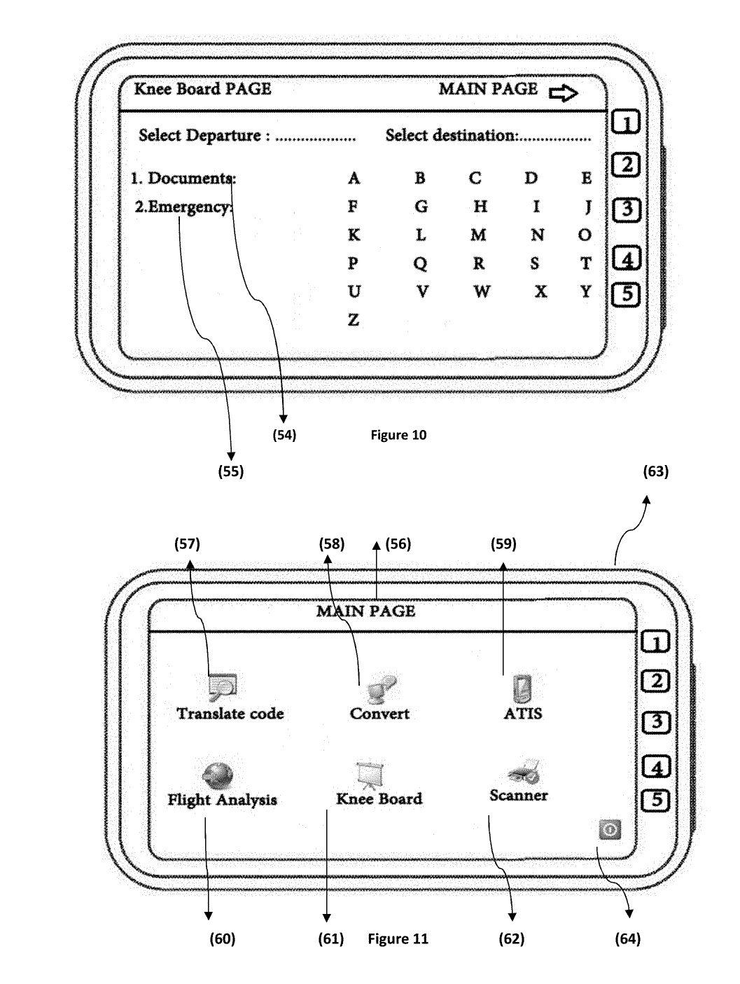

The last part of this system is known as KNEE BOARD PAGE, entering in you will be served with 10 different services just by entering the LOCATION INDICATORE:
1—Information section that includes Aeronautical information publication (AIP). (FIG. 8; Part 40)
2—Route IFR: this collection includes all of the rout maps. (FIG. 8; Part 41)
3—Frequency: Containing all of active and alternative frequencies of the route and airports around (FIG. 8; Part 42).
4—Alternate aerodrome: containing information of the departure, destination, alternative and accessible airports.
5—Weight and balance: In this section, the pilot can convert any kind of unit (conversation) (FIG. 9; Part 50) Nautical to Statute; Statute to nautical; Nautical to; kilometer; Kilometers to nautical; Kilometers to statute; Statute to kilometers; Feet to meters; Meters feet; Pounds to kilometers; Kilograms to pounds; Gallons to liters; Liters to gallons; Fahrenheit to Celsius; Celsius to Fahrenheit; Millibars to inches; Inches to millibars; Weight and balance calculators.
6—time: in this part the pilot can observe international time and do the following calculations: H. h to HH:MM:SS; HH:MM:SS to H.h; Leg time; Estimate time
7—calculator: a scientific calculator for doing all of calculations required by the pilot. (FIG. 9; Part 52)
8—map: containing a total map of the territory where we fly on. (FIG. 9; Part 53)
9—Documents: containing PDF format of all of the ICAO annexes of airplane booklet. (FIG. 10; Part 54)
10—Emergency

Any aircraft has a booklet containing all the information about it and covers various sections, this book called POH or AOM. It is considered as a non-separately part of flight cabin. One section of this book that is surely coloured different is emergency section. Of course this section is of a great importance in the aircraft and it is considered as super vital section, because in this section any events that may occur in the aircrafts, the way to prevent them and the necessary steps to prevent huge disasters are mentioned.

Therefore in the time of any event the pilot should refer to this book and seek for the considered section, find the considered case and finally do any steps that are mentioned in the book, but this process takes so much time, and it is possible to lose a vital moment even for some seconds, and lead to a serious problem. The considered system is able to read all of the emergency issues automatically after choosing the related section by the pilot, in audio form, so that the pilot will be able to do all of preventing actions. (FIG. 10; Part 55)

### DETAILED DESCRIPTION OF DRAWINGS

FIG. 1: the above figure explains a view of a window named Translate code page. This sections the operation of which was explained in details includes the following sections:
(1): Apparatus Input system including a paper scanner, a USB™, it can be connected to the internet that we use to receive the Encrypted information.
(2): Inputs are displayed on the top of the page.
(3): The Encrypted information is analyzed and decoded immediately after receiving and will be displayed in this section.
(4): We use this key to return to the main menu.

FIG. 2: the front flow chart explains how the translate code page works:
(5): Choosing the method of entering information to the apparatus: through internet channel and connection to the center or through scanning the report paper or receiving report file from the USB port.
(6): If you chose scanner or USB, just you should enter the information. So it will be analyzed immediately after receipt.
(7): If you chose internet connection to the center, information will be analyzed immediately after receipt.
(8): If the information was acceptable and recognizable, it will be sent immediately to the next stage for process. In otherwise the stage of receiving information should be repeated.
(9): Information processes is done with nervous channel and artificial intelligent, and analyzation and separation will be done.
(10): Finally it displays the interpretation and the reported code for the pilot.

FIG. 3: this figure displays a view of the window named Convert page. This section the operation of which is explained in details will automatically start working and convert all the conversations to the text after Reinforcement, just as the radio panel of aircraft is turned on and its frequencies are set.
(11): Displays the Conversations of the air traffic services which are converted to the text for the pilot and vice versa.
(12): The text that you observe here is the answer that was proposed for sending, immediately after analyzing the text, and its relies on recognition of key words of speech, which means finding a especial word or sentence that was used to predict the answer of the pilot in this system.
(13): Shows the frequency from which the information was received.

FIG. 4: the front flow chart explains how the convert page works.
(14): The process of converting the conversations to text from the beginning of communication of air traffic center with the pilot or vice versa starts (FIG. 4; Part 14).
(15) & (16): When the conversations begin the signals will be transferred to the sender. (FIG. 4; Part 15, Part 16)
(17): The receiver receives the signals and sends them to the reinforcement box.
(18): Radio signals enter the sound increaser box through the receiver and the quality of the sound will be improved. (FIG. 4; Part 18)
(19), (20), (21), (22): Signals will be sent to the radio and simultaneously will be played for the pilot through microphone and displayed for him by the converter of the voice to the text.
(23) & (24): The displayed text on the monitor will be processed through the formulation of Neural Network and Artificial Intelligent, and the system will extract the key words and compare them with the current information bank in the system.
(25): If there was an answer it will be displayed on the monitor.
(26): The proposed answer is displayed. (FIG. 4; Part 26)

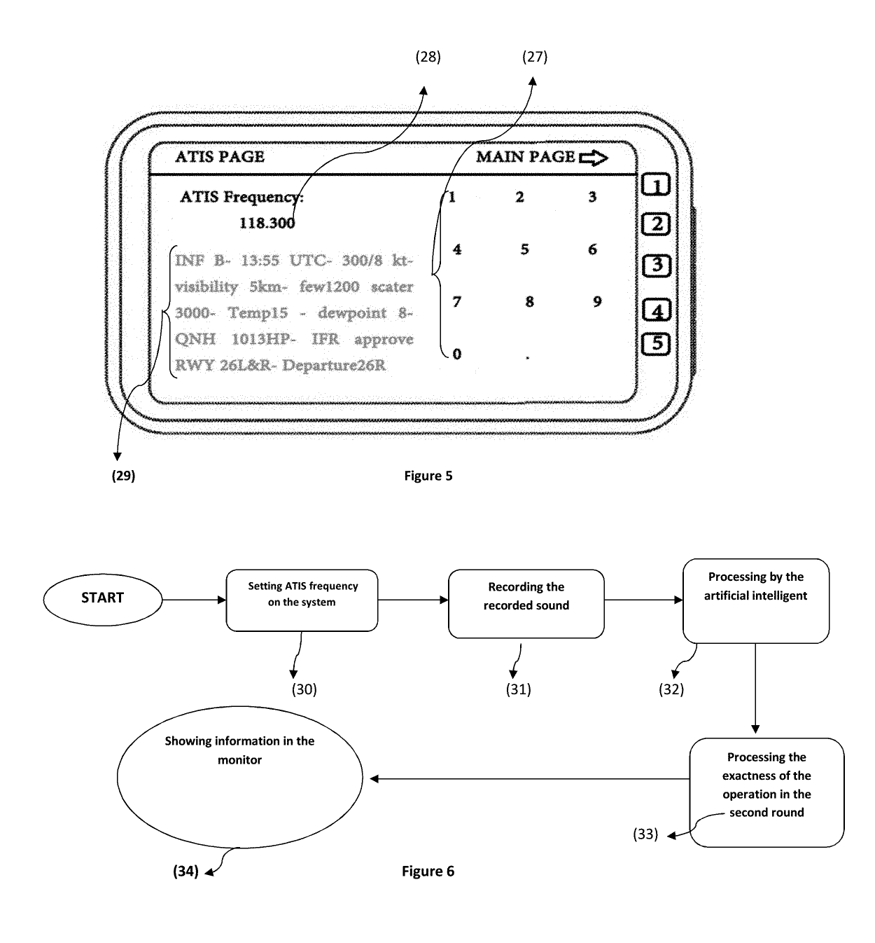

FIG. 5: displays a view of a window known as ATIS page. This section the operation of which was explained in details includes different parts:
(27): A touch screen section through which we can set the considered frequency.
(28): Displays the set frequency.
(29): The place for displaying the converted information to the text from ATIS frequency.

FIG. 6: The front flow chart explains how the ATIS page works.
(30), (32), (33) and (34): After setting ATIS frequency on the analyzer monitor, the system starts recording the sound of the speaker, and then converts the recorded information to text in two stages by artificial intelligent and technology of speech recognition, and finally displays it on the output monitor.

FIG. 7: The figure displays a view of a window known as flight analysis page. This section the operation of which was described in details, includes the following parts:
(35): The above page is related to the flight analyzer that recognizes the linear movements of the aircraft using the sensors that we install on the aircraft, without any use of satellite systems, and shows the linear display as we observe in the picture.
(36): As the analyzer displays linear movement of the aircraft, the pilot is able to check his flight with navigation maps under it (on the monitor), and measure the adoption and non-adoption of his operation.

FIG. 8: The figure displays a view of a widow known as Knee board page. This section the operation of which was explained in detail consists of different parts:
(37), (38), & (39): In this section the pilot can enter the departure and the destination of his flight in the appropriate place using a touch key board.
(40): In this section an operator can have access to the (AIP) aeronautical information publication.
(41): In this section an operator can have access to the (IFR) instrument flight rules.
(42): In this section an operator can have access to all the information about the active and alternative frequencies of the destination airport, required frequencies in the route, destination airport and all of alternative frequencies that may be required during the flight.
(43): In this section an operator can have access to the information about all of the airports accessible on your route.
(44): The next page will be displayed by pressing this key.
(45), (46), (47), (48) & (49): You will have access to the information of the section by pushing any one of the above keys.

FIG. 9: The figure displays another view of a window named Knee board page. This section the operation of which was explained in details consists of different sections including:
(50): In this section an operator can have access to the information about the weight and balance calculations.
(51): In this section an operator can have access to the time calculations.
(52): In this section an operator can have access to a calculator.
(53) In this section an operator can have access to the information about to the High/Low Altitude Enroot Chart.

FIG. 10: The figure displays a view of a window known as Knee board page. This section the operation of which was explained in details consists of different sections including:
(54): In this section an operator can have access to all of the available information about documents, annexes, texts, and books related to the aircraft and navigation rules.
(55): In this section an operator can have access to the information about risks threatening the flight and the way to prevent them both in two voice and written formats.

FIG. 11: The figure displays a view of the main window.
(56) the front page is the main page of the analyzer and reducer of human fault system in the trade aircraft flights, that has touch screen with a quality in the sever light, it is also shockproof and waterproof
(57), (58), (59), (60), (61), & (62): The operator is referred to the related sections by touching this sections.
(63): The apparatus starts by touching this section.
(64): The apparatus turns off by touching this section.

### DETAILED DESCRIPTION AND BEST MODE OF THE DISCLOSURE

This disclosure of an apparatus titled the analyzer and reducer of human fault system which is meant to prevent human faults made by human resources involved in the flights. Previously we became familiar with the principles of its operation and its various sections, and we described them in details. Now we will address the issue of how does each section operate?

FIG. 11 is the overall view of the invented analyzer and human fault reducer in airplane flight (FIG. 1) and in system number 1 (FIG. 1) data entrance is classified in four categories:
Leaf Scanner
USB receiving data file
Internet and satellite network receiver
Receiving radio signals through receiver in airplane

Then it sends all relevant data to the system number 62 named Scanner (FIG. 11, Part 62). In this part necessary processes will be done and the data are sent on allocation form to the systems number 57 (Translate code), 58 (Convert page), 59 (ATIS), 60 (Flight Analysis) and 61 (Knee Board).

As mentioned before, data entrance into the said system is done in four ways and saved in part 62 (Scanner) and then will be retrieved and processed using the unique algorithms (FIG. 11, Part 62). If These information and reports are about aviation meteorology it will be referred to Translate Code (57). (FIG. 11; Part 57)

As we can see in FIG. 1, the same report of aviation meteorology is presented in part number 2 of the analyzer system. These information are in the form of pre-defined code and relating to each other on chain basis and each code have pre-defined means and in this regard, system number 2 send each code on separate basis to system number 3 and system number 3 extract equal code from its data bank and display in monitor.

Radio signals that enter into system No. 1 (FIG. 1, Part 11) through airplane receiver, are recorded in vocal form and transferred to the system number 58 means convert page (FIG. 11, Part 58). In this section and using speech recognition system in addition to signals processing fields and especially audio signals and automatic speech recognition, we can also extend in other fields with regard to type of order. Applied enforcement methods are as follows:
methods on the following basis: Liftering, RCC, RASTA-PLP, PCA, CMS
methods of Improvement during speech: Spectra separation, Microphone Array and beam-forming
Methods on adjustment basis: MLLR and MAP
Methods on anticipation basis: PMC
Methods on speaker normalization: VTLN

Probable method of single, double, triple and foursome words for Persian and English languages.
Grammar GPSG rules for Persian language
Probable language grammar
Suitable partial for language model
Words clustering methods
Created special data bank for common aviation words

Allocable window in FIG. 3 introduced as convert page (FIG. 3) the basis of which was defined in above paragraph contains two parts: Upper part referred to as number 11, is the convert of speech to the text for the pilot (FIG. 3, Part 11) while the lower part of the window shown as number 12 is the convert of speech to text for the flight control unit (FIG. 3, Part 12).

FIG. 5 shows ATIS window structure. This section receives its required resources from the radio frequencies which are from airplane radio converts audio information of frequency to text using the technology described above, and shows them in part 29 of ATIS window (FIG. 5, Part 29). Parts 27 and 28 are also used for setting the intended frequencies and its display to the user in order to assure him of the accuracy of the presented information. (FIG. 5, Part 27 and Part 28).

In former paragraphs we said that one of the different types of the input entrance to the system that was shown in FIG. 11 was through internet and satellite (FIG. 11). Such a feeding is suitable for tracking airplane and its simultaneous show in window 60 named Flight Analysis Page (FIG. 11, Part 60) and reviewed in FIG. 7. In this picture, you can see that the input data from satellite depict on Tracking basis on aerial plan and system number 35 depict tracking with use of online algorithm on part to part basis in such a way that receive information from satellite and depict the linear tracking on plan (FIG. 7, Part 35). In system number 36, Approach Plan View which is design by governing country and provided for airplane manufacturing companies is shown, so the pilot can depict his online tracking route referred to in part 35 (FIG. 7, Part. 35) and compare them with each other and check his probable faults. (FIG. 7, Part. 36).

In picture 8, 9 and 10 there are some parts that we will explain separately. Section 40 help you to have access to AIP (Aeronautical Information Publication). Such data are prepare on Document basis by Aviation Organization of each country and we can save this document in this part to be able to use it when it is necessary. (FIG. 8, Part. 40). Section (41) you as an operator can have access to route information in IFR (Instrument Flight Rules) and again these are prepared on Document basis by Aviation Organization of each country and ICAO can save such a document in this part to be used in case of need (FIG. 8, Part. 41). (42) In this part as an operator, you are able to access all relevant data of active and alternative frequency of the departure airport, required frequencies on the route and the destination and all alternative frequencies that may be required en route. Such data is prepared on Document basis by Aviation Organization of each country. This document can be saved in order to be used in the necessary time (FIG. 8, Part. 42). (43) In this part as an operator, you are able to have access to all relevant data of all airports in route. Such a data prepare on Document basis by Aviation Organization of each country and can be saved in this section in order to be used when it is needed (FIG. 8, Part. 43).

While at least one exemplary embodiment has been presented in the foregoing detailed description, it should be appreciated that a vast number of variations exist. It should also be noted that the exemplary embodiments are only examples and are not intended to limit the scope, applicability or reconfiguration of the subject matter in any way. It being understood that various changes may be made in the function and arrangement of elements described in an exemplary embodiments without departure from the scope of the subject matter as set forth in the appended claims.

1- A method of accurately communicating information from an aircraft to a computer system at a ground location and back, comprising:
Obtaining audio input from an audio input device onboard of an aircraft,
A translate code section, utilizing artificial intelligent and voice recognition and presenting/reading out navigation reports to pilots and/or crew member in human voice via speakers on board of said aircraft;
a convert section, converting audio received from said audio input device and generating textual representation of one or more words; and storing and displaying as conversation data on said audio input on a display monitor;
Receiving, processing and converting Aerodrome traffic information service (ATIS) frequencies and navigation frequencies at specified time intervals, from a control unit located in an airport, to text and displaying as output frequency data on said display; a scanner section, further receives external data via a scanner on board of said aircraft and/or USB™.

2- The method of claim 1, further comprising receiving departure and destination information manually from said pilot or crew members onboard of said aircraft, wherein a kneeboard system displays said information as well as said ATIS frequencies, said navigation frequencies, height requirements, compulsory report, alternate route, alternate aerodrome and other data.

3- The method of claim 2, further comprising obtaining flight data from an avionics system onboard of said aircraft, and associating said flight date with text data prior to communicating said text data on said display, wherein said flight data encompasses all data received from said convert section, said translate code section, said scanner section and all of said frequencies.

4- The method of claim 3, wherein associating said flight data comprises appending said flight data as onboard data associated with said text data.

5- The method of claim 4, wherein communicating said text data comprises creating a data link message including said textual representation of said on or more words and said flight data, and displaying said text data arranged in accordance with time ordered sequence and/or based on emergency and/or preprogrammed order; wherein further concurrently displaying said one or more words and/or said text data, by an onboard computer on said display in graphical association with said flight data.

6- A flight analyzer and human error reducing system comprises: a computer operating system onboard of an aircraft having a display system having a touch screen, wherein said display system comprises a translate code page; a convert page; a ATIS page; a flight analysis page; a kneeboard page.

7- The system of claim 6, wherein said translate code page comprises an input obtaining system (scanner, USB™ and/or encrypted information received via internet) for obtaining input data, and displays all of said input data as well as navigation and control keys of said display system.

8- The system of claim 7, further comprising wherein said convert page obtains all of said input data as well as all conversations to text as soon as a radio panel of said aircraft is turned on; wherein said display system further displays conversations between said aircraft and air traffic services located on ground, as text; wherein all of said conversations are transmitted to a reinforcement box where quality and volume is increased and improved.

9- The system of claim 8, wherein in said ATIS page, desired frequencies to be received via said aircraft are set and received frequencies and their respective interpreted text is displayed.

10- The system of claim 9, wherein a flight analyzer recognizes a linear movement of said aircraft using onboard sensors without help from any satellite and further displaying said linear movement as graphical display above a navigation map, on said flight analysis page.

11- The system of claim 10, wherein in said kneeboard page a pilot has access to any data needed for navigating and controlling said aircraft, such as threatening risks.
